(19) United States
(12) Patent Application Publication
(10) Pub. No.: US 2004/0037944 A1
(43) Pub. Date: Feb. 26, 2004

(54) Dentally beneficial pet food and method of manufacture

(76) Inventors: Carolyn Jean Cupp, Liberty, MI (US); Michael J. Saylock, Kansas City, MI (US); Michael G. Rayner, St. Joseph, MI (US); Lorenzo Brescia, Elkridge, MD (US)

Correspondence Address: BELL, BOYD & LLOYD LLC, P. O. BOX 1135, CHICAGO, IL, 60690-1135, US

(21) Appl. No.: 10/239,366

(22) PCT Filed: Mar. 22, 2001
(86) PCT No.: PCT/EP01/03437

(51) Int. Cl. A23L 1/31

(52) U.S. Cl. 426/646

(57) ABSTRACT

There is provided a pet food product comprising an edible protein-rich body having reduced moisture content and a structure providing textural firmness capable of inducing thorough chewing behaviour in a pet to which it is fed and, through such behaviour, inhibiting the development of periodontal disorders in the pet animal. The food body preferably has a browned outer surface, achieved by exposure of the body to a source of dry heat. A method of producing such body includes steps of providing a coherent, edible, protein-rich body, causing moisture content of the body to be in the range from about 20% to 50% by weight and causing the body to have a structure capable of inducing thorough chewing by a pet. The method preferably includes reducing the moisture content of the body after it has been formed.

### FIELD OF INVENTION

This invention relates to a wet pet food that reduces build up of dental plaque and calculus on the teeth of pets. The pet food, when chewed by pets, causes mechanical, abrasive cleaning of the pets' teeth.

### BACKGROUND TO THE INVENTION

Many pets suffer from dental health problems. In particular, poor dental health is common in pet cats, particularly cats that consume a canned food diet. A primary factor in the development of these problems is the formation of plaque on the surface of the teeth. Plaque contains bacteria and other components that adhere to the surface of the teeth, accumulating both above and below the gum line and leading to inflammation, or gingivitis, and malodours in the dental cavity.

Contributing to the problem is the formation of tartar or dental calculus (mineralised plaque). Dental calculus (also known as tartar) forms on the tooth surface at or above the gum line and serves as a substrate for additional accumulation of plaque. Apart from causing gum irritation and eventually periodontal disease if left untreated, the calculus has an unsightly appearance.

Animals in the wild are less susceptible than pets to the formation of plaque and calculus due to the nature of the foods that they eat. Many of these foods mechanically abrade plaque and calculus from the teeth. Pets, however, are usually fed commercially available pet foods. While the commercially available pet foods are usually nutritionally superior, they do not in general subject the teeth of the pets to abrasive forces sufficient to clean the teeth. Even dried kibbles are able to abrade the teeth only to a very limited extent. This is because dried kibbles usually crumble when chewed by the pet.

There have been various attempts to deal with the problem. One of these makes use of chews made from rawhide or rawhide substitutes. By gnawing or chewing on the chews, the pet abrades calculus and plaque from its teeth. Further, as described in European patent publication No. 0272968, various oral care agents may be incorporated into the chews. A drawback with this approach is that it is only really applicable to dogs. Cats are usually not in the habit of gnawing or chewing on a chew. Also, rawhide based products are expensive.

Another approach has been to incorporate oral care agents into certain pet foods. For example, U.S. Pat. No. 5,000,940 discloses baked dog biscuits that contain a tetrasodium pyrophosphate salt. The salt is reported to cause a reduction in calculus accumulation. Also, European patent publication EP0205354 discloses baked dog biscuits that contain vegetable fibres to abrade the teeth of the dog when chewed. The drawback with both these products is that the biscuit crumbles upon being bitten. Hence the dog does not chew the product and little abrasion occurs. This reduces the efficacy of the products. Also, the products are not really suitable for cats.

A further approach is described in US patent 5,431,927. The pet food described in this patent is a dried product that contains aligned fibres. When chewed, it fractures along striations rather than crumbles. This is said to maintain contact between the product and the animal's teeth for a longer period of time, hence enhancing the abrasive effect. However, the product has to be produced using a specially coated die designed to permit laminar flow conditions within it. The laminar flow conditions are reported to cause alignment of the fibres within the product, leading to the fracturing of the product when bitten. The use of these dies unnecessarily complicates production of the product.

European patent publication EP 0 909 536 discloses a dried pet food based on a denatured protein and gelatinized carbohydrate matrix containing insoluble fibre and an humectant to promote reduced brittleness. However, this invention does not propose a solution to finding a wet pet food that is suitable for canning and that furthermore can assist in combating undesirable dental conditions in pets.

Therefore there is a need for a wet dental care pet food which is applicable to both dogs and cats and which may be produced without the need for special processing.

### SUMMARY OF INVENTION

According to the invention, there is provided a wet or cannable pet food that at least maintains and, preferably, improves dental health in a pet by inducing thorough chewing behaviour, thereby inhibiting development of periodontal disorders such as plaque and calculus build-up on the teeth of the pets relative to standard commercially available pet foods.

Hence, according to a first aspect of the invention, there is provided a pet food comprising an edible, food body being protein-rich and formulated to have a structure providing textural firmness capable of inducing thorough chewing behaviour in a pet when fed in use to such pet and, through such behaviour, inhibiting the development of periodontal disorders in said pet.

The periodontal disorders may include build-up of plaque and calculus on said pet's teeth.

The chewing behaviour inhibits development of such disorders preferably by promoting mechanical abrasion of the food against the teeth.

In a preferred form of the invention, the structure of the pet food is such that the body has a moisture content in the range from about 20% to 50% by weight.

The body preferably comprises at least about 20% by weight of protein.

In a further preferred form of the invention, the structure is such that the body has a minimum lateral dimension of at least about 8 mm. Preferably this dimension is from 8 to 12 mm, but increases for larger dogs.

The invention extends to the use of a pet food in inhibiting the development of periodontal disorders in a pet, the food comprising an edible, protein-rich body having a structure providing textural firmness capable of inducing thorough chewing behaviour in a pet when fed in use to such pet, such behaviour being effective to inhibit the development of said periodontal disorders.

The periodontal disorders may include build-up of plaque and calculus as aforesaid.

In a preferred form of the invention, the edible pet food body has a structure such that moisture content is from about 20% to 50% by weight, more preferably from 30 to 40% by weight and most preferably about 33% by weight.

In a preferred embodiment, the body has a generally blocky shape. In other embodiments, the shape may be more rounded, however.

The body preferably has an outer surface that has been exposed to a source of dry heat. The dry heat may cause browning of the surface. The dry heat source may be provided by a process selected from any one of roasting, grilling, frying, baking and combinations thereof. Where the process selected is frying, it is preferably flash frying.

In an embodiment of the invention, the structure is layered.

The structure may further comprise an exterior zone and an interior zone, the exterior zone having a lower moisture content than the interior zone.

In a further preferred form of the invention, the body comprises from about 2% to about 10% by weight of ash.

According to a second aspect of the invention, a method of inhibiting the development of periodontal disorders in a pet comprises allowing the pet to chew and swallow a pet food comprising an edible formulated protein-rich body having a structure providing textural firmness capable of inducing thorough chewing behaviour in the pet, such behaviour being effective in inhibiting the development of said periodontal disorders.

In a preferred form of the invention, the method includes reducing, by abrasion, build-up of plaque and calculus on said pet's teeth.

In a preferred form of the invention, the structure is such that the moisture content of the body is in the range from about 20% to 50% by weight.

In preferred embodiments, the moisture content is from 30 to 40% by weight and more preferably about 33% by weight.

The minimum lateral dimension of the body is preferably at least 8 mm and more preferably in the range from about 12 to 50 mm.

In a preferred form of the invention, the structure is layered.

In a further preferred form of the invention, the body comprises from about 2 to 10% by weight of ash.

In preferred embodiments, the body will have a generally blocky shape.

Further according to the invention, the structure comprises an exterior zone and an interior zone, the exterior zone having a lower moisture content than the interior zone. The exterior zone preferably presents a browned outer surface.

The browning of the surface may be achieved by roasting, grilling or frying, preferably flash frying.

According to a third aspect of the invention, a process for producing a pet food having a structure such that when being chewed by a pet, the body is capable of inhibiting development of periodontal disorders on said pet's teeth, includes the steps of

providing a coherent edible protein-rich body

reducing moisture content of the body to provide textural firmness capable of inducing thorough chewing behaviour in the pet, such behaviour being effective in inhibiting the development of said periodontal disorders and

increasing firmness of the body.

The periodontal disorders may include build-up of plaque and/or calculus.

The inhibiting of the development of the disorder preferably includes reducing, by mechanical abrasion, the said build-up.

The steps of reducing moisture and increasing firmness are preferably accomplished by exposing the body to a source of dry heat. Exposure to dry heat may cause browning of the surface.

In a preferred form of the invention, the method includes searing at least a portion of the surface.

Searing may include charring.

The searing may be accomplished by one or more of grilling, baking, roasting or frying the chunks. Preferably the frying is flash frying.

The method may include reducing the moisture content of the body to about from 20 to 50% by weight.

The step of providing the body containing coagulated protein may include the steps of forming a meat emulsion having a moisture content from 45% to 80%; heating the emulsion; maintaining the heated emulsion at a pressure in excess of the vapour pressure of water until the emulsion coagulates into a coherent body and reducing the pressure. The process may further include dividing the body into a plurality of pieces. The pressure is preferably reduced to about ambient.

Preferably, the meat emulsion has a protein: fat ratio of at least 1.5:1 by weight.

In preferred embodiments, the process includes deaerating and comminuting the emulsion prior to heating it.

The invention in another aspect provides a pet food product for use in the development of periodontal disorders in a, the product comprising

a sealed container; and

a plurality of firm, chewable protein-rich food bodies in the container,

each such body having structure to provide a moisture content of at least about 20% by weight.

In a preferred form of the invention, at least some of the bodies have been exposed to a source of dry heat. They may as a result have an outwardly browned appearance. The dry heat source may be provided by any one or more of frying, baking, roasting and grilling, preferably by flash frying.

Further preferably, the container includes no added water or gravy.

In a further preferred form of the invention, the bodies are closely contained in the container. Preferably, they may be tightly packed. Further preferably, the container has substantially no visible free moisture.

The container may comprise a sealable can. The can, once sealed, may be retorted.

### DETAILED DESCRIPTION OF EMBODIMENTS

Embodiments of the invention are now described, by way of example only.

The invention is a pet food product in the form of a formulated food body. The food body is protein-rich, has a reduced moisture content and a structure that has textural firmness capable of rendering cleansing benefits to the teeth of an animal under the action of chewing. The body is produced from a thermally gellable protein source, preferably mixed with a starch source. The body is coherent in that it does not readily break up, but requires prolonged chewing by a pet before it exhibits signs of fragmentation. The chewing is prolonged in that is of a longer duration than is generally observed in respect of prior art foods of similar type.

A plurality of the bodies may be provided in a sealed container. They may be mixed with less resilient or less chew-resistant bodies when provided as a complete meal, for example in a canned or pouched product format. Each of the chew-resistant bodies of the invention, however, is coherent, firm and chewable and is suitably sized to facilitate effective plaque and/or calculus (also known as tartar) reduction on the teeth of the end consumer pet, as a result of mechanical abrasion through chewing. The body contains protein in an amount of at least 20% and has moisture content in the range from about 15% to 50% by weight. In this form, the body or piece is particularly suited for feeding to a cat or a dog, depending respectively on the final product snake-up, as set out more fully below.

In a preferred embodiment, the body includes from about 2% to 10% by weight of ash. A more preferred ash content is from 4% to 7% by weight.

The protein, starch and other ingredients may be from any suitable source, the choice thereof being largely determined by nutritional needs, palatability considerations, and the type of food to be produced.

The protein source may be a vegetable protein source, an animal protein source, or a mixture of these protein sources. Suitable vegetable protein sources are gluten, wheat protein, soy protein, rice protein, corn protein, and the like. These proteins may be provided in the form of flours, concentrates and isolates as desired. Animal proteins are however preferred. Suitable animal protein sources are muscular or skeletal meat of mammals, poultry, and fish; meals such as meat meal, bone meal, fish meal, and poultry meal; by-products such as hearts, liver, kidneys, tongue and the like; and milk proteins. Usually, the protein content does not exceed 90% by weight. Preferably protein content is in the range from about 25% to 65% by weight and, more preferably in the range from about 30% to 45% by weight.

The starch source is conveniently a grain such as corn, rice, wheat, barley, oats, or soy, and mixtures of these grains. The grain is conveniently provided in the form of a flour. Pure or substantially pure starches may also be used if desired. If flours are used, they will also provide some protein. Hence it is possible to use a material which is both a protein source and a starch source. Generally the starch content of the pieces will be in the range from about 5% to 50% by weight. A preferred range is from about 10% to 40% by weight starch.

Various other ingredients, for example, salt, spices, seasonings, vitamins, minerals, flavoring agents, lipids and the like may also be incorporated into the thermally gellable mixture as desired. If added, the lipids may be any suitable animal fats; for example tallow, or may be vegetable fats.

The moisture-reduced, formulated food product is produced by forming a thermally gelled mass, forming the mass into pieces, and then texturizing them by reducing the moisture of the pieces, preferably by frying them.

The thermally gelled mass may be produced in many different ways as desired.

For example, a thermally gellable mixture may be prepared from water, protein and all the other ingredients to be included in the moisture-reduced, formulated food product. The thermally gellable mixture is then heated and formed into layers. This may be done as described in U.S. Pat. Nos. 4,781,939 and 5,132,137; the disclosures of which are incorporated by reference. As described in these patents, the thermally gellable mixture is fed to an emulsion mill in which the mixture is subjected to rapid mechanical heating and shearing. Any suitable emulsion mill may be used, for example the emulsion mill disclosed in U.S. Pat. No. 5,132,137. Other suitable emulsion mills are commercially available under the trade name of Trigonal and may be obtained from Siefer Machinenfabrik GmbH & Co KG, Bahnhofstrasse 114, Postfach 101008, Velbert 1, Germany.

In the emulsion mill, the temperature of the mixture is raised to the desired gelling temperature within a very short time; usually less than one or two seconds. Preferably the temperature is raised to about 100° C. to about 120° C. Alternatively, the temperature may be raised to in the range of about 45° C. to about 75° C. as described in U.S. Pat. No. 5,132,137. Usually the mechanical energy generated in the emulsion mill will be sufficient to heat the mixture to the desired temperature but this may be supplemented by the injection of superheated steam.

The heated mixture is ejected from the emulsion mill in a thin stream into a holding tube. Because the heat mixture enters the holding tube in a thin stream, it forms thin layers upon heated mixture already in the holding tube. The layered, heated mixture in the holding tube then gels while moving slowly along the holding tube. Each layer of the layered, heated mixture remains substantially, visually distinct. The residence time of the heated mixture in the holding tube is sufficient for the mixture to gel into a firm gelled, product upon reaching the exit of the holding tube. At this stage, the gelled product has the highly striated appearance and the texture of meat.

In another example, the thermally gelled mass may be produced by emulsifying water and the ingredients to be included in the moisture-reduced, formulated food product. A high speed emulsifier or homogenizer is particularly suitable for emulsification. If necessary or desired, a gelling agent may be added. The emulsion is then heated to thermally gel the emulsion to provide a thermally gelled mass; for example in a mixer-cooker or extruder. The thermally gelled mass may then be forced through an orifice such as an extrusion die to provide a gelled product suitable for cutting into pieces.

The gelled product obtained from the process used is then cut into pieces in a suitable cutter. The pieces thus formed are preferably of a size suitable for use in a pet food; for example of dimension of about 10 mm. The pieces may then be screened to remove fines.

The pieces are then texturized by subjecting them to a moisture reducing process. Various dry heat processes—in particular those providing intense dry heat—are suitable, for example grilling, frying, roasting and baking. Frying is conveniently carried out in a deep fat frying apparatus. Any suitable deep fat frying apparatus may be used. The fat used to fry the pieces may be any suitable animal or vegetable fat or oil. Suitable vegetable oils are peanut oil, corn oil, cottonseed oil, sunflower oil, hydrogenated soybean oil and the like. Beef tallow is a suitable animal oil. The temperature of the oil is preferably in the range of about 150° C. to about 200° C.; for example about 160° C. to about 180° C.

The pieces are fried for a time sufficient to dry them to a moisture content of less than about 45% by weight; for example about 30% to about 40% by weight. Depending upon the temperature of the oil, the time may vary from about 5 seconds to about 2 minutes; preferably, for example, from about 30 seconds to about 1 minute. The specific time and temperature needed for any particular product may be readily determined by a skilled person.

In a preferred embodiment, the chunks or bodies were flash fried, so as to reduce moisture and increase firmness.

The fried pieces may then be drained and cooled; for example to about 15° C. to about 35° C.

The fried pieces may then be packed into suitable containers; for example cans or pouches. The containers are sealed. Preferably they are retorted. Presented in this manner, the fried pieces may be fed to pets as a meal or even as part of a meal.

Prior to packing, the fried pieces may further be coated with an acid. The acidic coating, thus applied, may comprise from 1% to 5% of the total weight of each piece. Under the heat of retortion, acid in the coating may react with sugars in the contained pieces and cause enhanced browning of their surfaces. The browning is thought to enhance palatability.

As an alternative to frying, or even in a step complemental to moisture reduction by frying, the pieces may be dried under direct heat, such as in a hot air dryer. The pieces may be passed through a high velocity stream of hot air, such as countercurrently in a drying tunnel, where the temperature is conveniently in the range from about 140° C. to 180° C. Residence time will depend to some extent on hot air relative velocity, temperature, ambient humidity and initial moisture content of the pieces to be dried. It is found that residence time in a conventional countercurrent high velocity dryer may be from about 4 to 6 minutes to achieve a final moisture content of 20% to 50% by weight.

In preferred embodiments of the invention, the dried pieces preferably comprise about 10% or less by weight of starch; about 20% to about 40% by weight of protein; about 15% to about 25% by weight of lipid; and about 30% to about 40% by weight of moisture. If additional ingredients such as salts, sugars, spices, seasonings, flavoring agents, minerals, and the like are included in the fried pieces, these additional ingredients preferably make up about 0.5% to about 15% by weight of the fried pieces.

It is important that the product chunks are sized to assist in achieving the reduction of plaque and tartar when being chewed by the consuming pet.

In the case of medium to large dogs, it is found that the chunks should preferably be within the following size limits: shortest lateral dimension from 8 mm to 12 mm and longest from 16 mm to about 25 mm. It is however, convenient to consider the dimensions in terms of an equivalent or nominal diameter, this being the diameter of a sphere having equal volume to the non-spherical body in question. Although the body may indeed be a sphere, it is found that generally bodies of generally blocky proportions are preferable. Without intending to be bound by theory, blockier shapes, because of having edges and comers, are thought to provide more varied forms of contact with the teeth of the chewing pet animal than more rounded shapes, thus increasing the randomness of contact time, penetration angle and contact angle. However, it will be appreciated that not only blocky and rounded shapes, but also shapes comprising combinations thereof are within the scope of this invention and the appended claims.

An advantage of the invention is that the structure of the food body, in having been reduced to lower moisture and to provide firmer, chewy texture in a relatively large size, induces the pet, be it cat or dog or the like, to spend more time chewing it. The resulting extended chewing time, achieved through use of the food bodies as a pet meal, is thought to cause the loosening of plaque and tartar on its teeth and help clean its teeth. Thus a method of inhibiting the development of these and related periodontal disorders includes feeding the food product of the invention to a pet and allowing the pet to chew the individual food bodies. Chewing should be allowed to continue for as long as desired by the pet. The feeding of the product pieces should be repeated regularly.

It will be appreciated that numerous modifications and variations may be made to the embodiments described above without departing from the invention. Further, while the moisture-reduced, formulated food product is particularly suitable for us as a pet food, it may be used as a human food. Of course, the particular flavors used will differ depending upon whether humans or animals consume the food product.

The invention may further be illustrated with the reference to the following non-limiting examples.

### EXAMPLE 1

A base mix for producing a thermally gellable mixture is prepared from meat protein, wheat gluten, de-fatted soy flour, other ingredients and water in the following proportions by weight:

69.0% Meats

18.5% Wheat

5.0% Soy Flour (protein and/or starch source)

4.5% Water

3.0% Other (minerals, vitamins, flavors, etc.)

The thermally gellable mixture is run through an emulsion mill (a Trigonal Mill obtained from Siefer Machinenfabrik GmbH & Co KG). The heated mixture leaves the emulsion mill at a temperature of about 110° C. and is discharged into a holding tube. The residence time in the holding tube is less than 6 minutes. The gelled product leaving the holding tube is cut into pieces of about 8 mm length. The pieces have a striated, meat-like appearance.

The pieces are sieved to remove fines. The moisture content of the pieces is about 55% by weight. The pieces are then transferred to a deep fat, batch fryer in which they are fried in vegetable oil at a temperature of about 187° C. for about 50 seconds. The pieces are then removed, allowed to drain in frying baskets, and cooled to ambient temperature. The fried pieces retain their striated, meat-like appearance.

The composition of the pieces after frying was determined to be as follows (weight %):

33% Protein

20% Fat

35% Moisture

6% ash

Finally, the pieces were packed in to a sealable can without any gravy or water being added. The can was sealed and retorted.

### EXAMPLE 2

35 fried pieces obtained using the process of example 1 were subjected to texture analysis using a TA-XT2 Texture Analyser obtained from Stable Micro Systems, Inc. The Texture Analyser was fitted with a stainless steel blade having a length of about 73 mm, a width of about 25 mm and a thickness of about 3 mm, tapering to a point at a 45 degree angle. The Texture Analyser was operated at a speed of 5 mm/s and a contact force of 100 g.

Each of the 35 pieces was in turn placed on a base under the point of the blade. The blade point was moved downward and into the piece. The compression force and the time were recorded at a rate of 200 recordings per second and plotted against each other on a graph. The area under the graph was determined. The values obtained for all pieces were then averaged.

For comparison, the process was repeated for samples made up of 35 pieces of comparable test products. The results were as follows:

| | Moisture | | Peak Force |
|---|---|---|---|
| Product | (%) | Area under curve | (g) |
| Product of Example 1 | 33 | 5606.48 | 3564.38 |
| Chunk and Gravy | 75 | 1289.64 | 629.30 |
| product | | | |
| Chunk and Water | 60 | 763.14 | 397.50 |
| product | | | |

The results indicate that the pieces of Example 1 are the most resistant to compressive downward force and to penetration.

Because the product of example 1 is firmer than the comparison products, an animal chewing it needs to chew with more force and for a longer period-of time in order to accomplish effectively complete mastication. Therefore the animal's teeth are subjected to improved mechanical cleaning through more thorough chewing.

### EXAMPLE 3

A group of 30 healthy cats was used in a trial to determine efficacy of the product of example 1 in inhibiting the development of periodontal disorders. Cats which were known readily to consume canned foods were selected. The cats were first examined to identify those without obvious dental or oral cavity problems. The cats were then given a complete veterinary, physical examination. The cats were divided into two groups each of 15 cats, with an even distribution of cats susceptible to calculus formation in each group. During the trial, the cats were allowed ad libitum access to water and food and were fed once daily. The food consumption of each cat was monitored daily. The weight of each cat was recorded at the start of the trial and then upon weekly intervals.

On the day prior to the trial, each cat was subjected to complete dental prophylaxis in which all supra- and sub-gingival deposits of plaque and calculus were carefully removed. Also, the cat's teeth were thoroughly polished.

On the day of the trial, each group of cats was randomly allocated a different food product and fed that product exclusively for the duration of the trial. One group (Group 1) was fed the canned product of Example 1 while the other group (Group 2) was fed Friskies Turkey and Giblets canned loaf product. (Friskies is a trade mark of Société des Products Nestlé S:A:, Vevey, Switzerland).

After 7 days of being fed the same food product, a few drops of a 3% erythrosin plaque-disclosing solution were applied to the teeth of each cat and then thoroughly rinsed off with tap water. Plaque evaluation was then carried out on gingival and occlusal halves of the upper and lower canines, upper 3^{rd} and 4^{th} premolars, lower 3^{rd} and 4^{th} premolars, and lower 1^{st} molars. An assessment of the buccal tooth surface that is covered with plaque was made according to the following scale:

0=no observable plaque;

1=plaque covering less than 25% of the tooth surface;

2=plaque covering 25% to 50% of the tooth surface;

3=plaque covering 50% to 75% of the tooth surface; and

4=plaque covering greater than 75% of the tooth surface.

Plaque thickness was assessed as follows:

1=light or thin, a light pink colour;

2=medium, a moderate or medium shade of red; and

3=heavy or thick, a dark bright shade of red.

A score was then obtained by multiplying the coverage score by the thickness score for each half of the 14 teeth to give a score ranging from 0 to 12. The score S for each half of a tooth were added to provide a whole tooth score. The whole tooth scores were then averaged.

On the 28^{th} day of the trial, evaluation of calculus was similarly performed for each animal on the proximal, mesial and distal thirds of the 14 teeth previously examined. The scores for each third of a tooth were added to provide a whole tooth score and all whole tooth scores were averaged.

Scores for all animals in each group are averaged and the results are as follows:

| | Plaque score at 7 | Calculus score at |
|---|---|---|
| Product | days | 28 days |
| Example 1 | 5.89 | 3.15 |
| Friskies Turkey & | 7.58 | 5.09 |
| Giblets | | |

The results above indicate that the product of example 1 shows significantly improved cleaning of the cats' teeth over a commercially available canned food. These results correlate with findings in respect of example 4 below.

### EXAMPLE 4

The process described in example 1 was repeated except that the pieces produced were not fried but were grilled using a Berief belt grill.

Prior to grilling, the pieces were mixed with vegetable oil to make up 10% by total mass. The pieces were then exposed to the grill for 2 minutes 25 seconds at 260° C. This resulted in the grilled pieces being seared on two opposite sides and having substantially the same size, appearance and apparent texture as the fried chunks of example 1.

### EXAMPLE 5

The production process of example 1 was repeated, this time with the exception that, before frying, the chunk sizes were reduced to pass through a 7×7 grid, This translated into an average chunk dimension of approximately 6 mm.

### EXAMPLE 6

Dental efficacy trials following the same protocol as described in example 3 above, were performed to compare the products of example 4 and 5 with a commercially available canned product.

The results are summarised in the immediately following table:

| Product | Plague score at 7 days |
|---|---|
| Example 4 | 7.34 |
| Friskies Salmon Loaf | 8.50 |
| Example 5 | 7.79 |
| Friskies Salmon Loaf | 7.91 |

It was apparent that the large sized, chewy chunks of example 4 were dentally efficacious when compared with Friskies Turkey & Giblets. However, the small chunks of example 5 produced no notable advantage. This pointed to th combination of chewy, firm texture and size as being surprisingly beneficial.

### EXAMPLE 7

The process described in example 1 was repeated on a different starting formulation. The resulting pieces were not dried by frying, but were dried in a hot air (high velocity) dryer for 4.5 minutes, at temperatures ranging from 140 C.-178 C. with progress through the dryer. This resulted in pieces having a substantially blocky, cubic shape of 9 mm size, and appearance and texture as observed in the fried chunks of example 1. These pieces did not, however, have an obvious oily appearance. The composition of the dried pieces was determined in terms of weight percent to be moisture 45%, protein 35%, fat 15% and ash 2%.

### EXAMPLE 8

Coherent pet food pieces were produced by the process described in example 1, except that the pieces produced were subjected to moisture reduction in a hot air (high velocity) dryer as in example 7. A residence time of 6 minutes, at temperatures ranging from 165° C.-175° C. within the dryer, resulted in pieces having substantially the same appearance and texture, as observed in the chunks of example 7. These pieces did not have an obvious oily appearance. They were 10 mm square with a longest dimension of about 22 mm, thus having an elongated appearance with obvious comers. Moisture reduction to 24% by weight was achieved, the composition further comprising, by weight, 61% protein, 8% fat and 5% starches.

1. A pet food comprising an edible, formulated, protein-rich body having a structure providing firmness of texture capable of inducing thorough chewing behaviour in a pet when fed in use to such pet and, through such behaviour, inhibiting the development of periodontal disorders in said pet.

2. A pet food according to claim 1 wherein the periodontal disorders include a build-up of at least one of plaque and calculus on said pet's teeth.

3. A pet food according to claim 1 wherein the induced chewing behaviour inhibits development of the disorders by promoting mechanical abrasion of the food against an affected tooth.

4. A pet food according to claim 1 wherein the formulated body has a moisture content of about 20% to 50% by weight.

5. A pet food according to claim 4 wherein the moisture content is from 30% to 40% by weight.

6. A pet food according to claim 1 wherein the body has a minimum lateral dimension of at least 8 mm.

7. A pet food according to claim 1 wherein the body has a generally blocky shape.

8. A pet food according to claim 1 wherein the body has a surface that has been exposed to dry heat of sufficient intensity and for sufficient duration to cause browning thereof.

9. A pet food according to claim 1 wherein the body comprises at least 20% protein.

10. A pet food according to claim 1 wherein the structure is layered.

11. A pet food according to claim 1 wherein the structure comprises an exterior zone and an interior zone, the exterior zone having a lower moisture content than the interior zone.

12. A pet food according to claim 1 wherein the body comprises from 2% to 10% by weight of ash.

13. Use of a pet food in inhibiting the development of periodontal disorders in a pet, the food comprising an edible, protein-rich body having a structure providing textural firmness capable of inducing thorough chewing behaviour in a pet when fed in use to such pet, such behaviour being effective to inhibit the development of said periodontal disorders.

14. Use according to claim 13 wherein the periodontal disorders include a build-up of at least one of plaque and calculus on said pet's teeth.

15. Use according to claim 13 wherein the induced chewing behaviour inhibits development of the disorders by promoting mechanical abrasion of the food against an affected tooth.

16. Use according to claim 13 wherein the formulated body has moisture content of about 20% to 50% by weight.

17. Use according to claim 13 wherein the body has a minimum lateral dimension of at least 8 mm.

18. Use according to claim 13 wherein the body has a generally blocky shape.

19. Use according to claim 13 wherein the body comprises at least 20% protein by weight.

20. A method of inhibiting the development of periodontal disease in a pet comprising allowing the pet to chew and swallow a pet food comprising an edible formulated protein-rich body having a structure providing textural firmness capable of inducing thorough chewing behaviour in the pet, such behaviour being effective to inhibit the development of said periodontal disorders.

21. A method according to claim 20 wherein the periodontal disorders include build-up of plaque and calculus.

22. A method according to claim 21 wherein allowing the pet to chew the body reduces, by abrasion, build-up of plaque and calculus on said pet's teeth.

23. A method according to claim 20 wherein the body has a structure such that the moisture content of the body is in the range from about 20% to 50% by weight.

24. A method according to claim 20 wherein the body has a minimum lateral dimension in the range from 8 mm to 50 mm.

25. A method according to claim 20 wherein the structure is layered.

26. A process for producing a pet food having a structure such that when being chewed by a pet, the body is capable of inhibiting development of periodontal disorders in the pet, includes the steps of providing a coherent, edible, protein-rich body, causing moisture content of the body to be in th range from about 20% to 50% by weight and causing the body to have a structure capable of inducing thorough chewing by said pet.

27. A process according to claim 26 including exposing the body to a source of dry heat.

28. A process according to claim 27 wherein the exposure to dry heat includes causing browning of the surface of the body.

29. A process according to claim 28 wherein the exposing includes searing at least a portion of the surface of the body.

30. A pet food product for use in inhibiting development of periodontal disorders in a pet, the product comprising a sealed container; and a plurality of firm, chewable protein-rich food bodies in the container, each such body having structure to provide a moisture content of at least about 20% by weight.

31. A product according to claim 30, wherein the disorders include plaque and calculus build-up on the pet's teeth.

32. A product according to claim 30 wherein at least some of the pieces have been exposed to a source of dry heat.

33. A product according to claim 32 wherein the dry heat source is provided by frying.

34. A product according to claim 33, wherein the frying is flash frying.

35. A product according to claim 30, wherein the bodies are closely contained in the container.

36. A product according to claim 35, wherein the bodies are tightly packed.

37. A product according to claim 35, wherein the container contains substantially no free moisture.

38. A pet food comprising an edible, formulated protein-rich body having a structural coherence for providing firmness of texture capable of inducing thorough chewing behaviour in a pet when fed in use to such pet, the body comprising from about 20% to 45% by weight moisture and from about 30% to 60% protein.

39. A pet food composition according to claim 38 comprising from about 5% to 50% by weight starch.

40. A pet food product comprising a body having a blocky shape and an acidic coating, the coating comprising form about 1% to 5% of the weight of the body, and the body further comprising from about 30% to 45% by weight protein and from about 30% to 40% by weight moisture.

41. A pet food product comprising a chewable body having a blocky shape and having been dried to have moisture content from about 30% to 40% by weight and having lateral dimensions in the range from about 8 mm to 50 mm.

42. A pet food product comprising a moisture-reduced body formulated and dried to have a chewy texture, an acidic coating, a moisture content in the range from about 30 to 40% by weight and protein content from about 20 to 45% by weight.

43. A pet food product comprising a dried, protein-rich body having a chewy, layered structure capable of inhibiting the development of periodontal disorders in a pet when thoroughly chewed, the moisture content of the body being in the range from about 20 to 50% and the protein content from about 25 to 45% by weight.
